(19) United States
(12) Patent Application Publication
(10) Pub. No.: US 2015/0204458 A1
(43) Pub. Date: Jul. 23, 2015

(54) NON-INTRUSIVE POSITION DETECTOR FOR VALVE ACTUATOR

(71) Applicant: Cameron International Corporation, Houston, TX (US)

(72) Inventors: Graham M. Taitt, Longford (IE); Ryan M. Ford, Castlepollard (IE)

(73) Assignee: Cameron International Corporation, Houston, TX (US)

(21) Appl. No.: 14/172,735

(22) Filed: Feb. 4, 2014

Related U.S. Application Data
(60) Provisional application No. 61/929,878, filed on Jan. 21, 2014.

(51) Int. Cl. F16K 37/00

(52) U.S. Cl. CPC F16K 37/0058

(57) ABSTRACT

A non-intrusive position detector is provided. In one embodiment, a system includes a valve having a main body and an actuator to control flow through the valve. The actuator can be disposed within an actuator housing coupled to the main body. The system also includes a position detector including a camera mounted inside a detector housing. The detector housing can be installed over an aperture in the actuator housing such that the actuator within the actuator housing is in view of the camera through the aperture. A processor can be used to determine the position of the actuator from image data collected by the camera. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources from the earth. Particularly, once a desired subterranean resource such as oil or natural gas is discovered, drilling and production systems are often used to access and extract the resource. These systems may be located onshore or offshore depending on the location of a desired resource. Further, such systems generally include a wellhead assembly mounted on a well through which the resource is accessed or extracted. These wellhead assemblies can include a wide variety of components, including valves and chokes for regulating fluid flow. Various fluid conduits can also use valves and chokes in a similar manner. Such valves typically include movable actuators for controlling operation of the valves.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to a position detector for determining the position of a moving object, such as an actuator of a choke or other valve. The position detector can be provided with one or more cameras and other electronics mounted within a housing, which can be installed on an actuator housing or other component. In one embodiment, the position detector is non-intrusive and is installed over the viewing port of an actuator housing to enable the camera to view a spring plate of a gate valve or choke actuator. The position detector is configured to acquire image data of an actuator (or other moving object of interest) and process that data to determine the position of the actuator. Indications of the determined position may be transmitted to another device for review by a user.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 is a block diagram of a system having various valves and chokes for regulating fluid flow in accordance with one embodiment;

FIG. 2 is a cross-section illustrating a position detector attached to a valve actuation assembly, the position detector having multiple cameras that enable the detection of the position of an actuator of the actuation assembly, in accordance with one embodiment;

FIG. 3 is a cross-section illustrating a position detector and valve actuation assembly similar to those of FIG. 2, differing in that the position detector includes only a single camera in accordance with one embodiment;

FIGS. 4 and 5 are detail views generally representing the tracking of a spring plate of the actuation assembly of FIG. 2 in accordance with one embodiment;

FIG. 6 is a detail view of an end of the spring plate of FIG. 4 showing a reflective material added to the end of the spring plate to facilitate tracking of the position of the spring plate in accordance with one embodiment; and

FIG. 7 is a block diagram representing certain components of a position detecting and transmitting system in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

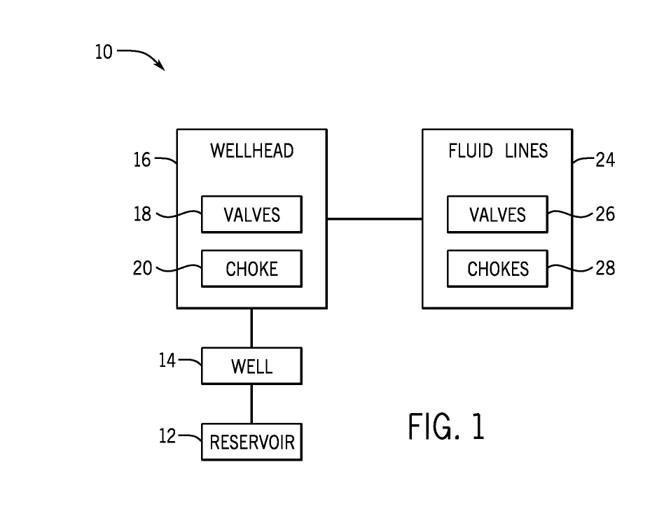

Turning now to the present figures, a system 10 is illustrated in FIG. 1 in accordance with one embodiment. In some instances, the system 10 is a production system that facilitates extraction of a resource, such as oil or natural gas, from a reservoir 12 through a well 14. Wellhead equipment 16 is installed at the well 14. As here depicted, the wellhead equipment 16 includes valves 18 and a choke 20. The valves 18 regulate flow of various fluids at the wellhead equipment 16. The valves 18 can include any of various types of valves, such as gate valves or ball valves. In at least some embodiments, the choke 20 is an adjustable choke that receives fluid (e.g., production fluid) and can be actuated to change the amount of fluid flow through its body. Adjustable chokes can include various trims, like plug-and-cage trims, sleeve trims, or needle-and-seat trims, for instance.

Fluids may be conveyed to or from the wellhead equipment through fluid lines 24. Examples of such fluid lines 24 include pipelines, flowlines, choke and kill lines, and injection lines. As depicted in FIG. 1, the fluid lines 24 also include valves 26 and chokes 28 for regulating fluid flow through the fluid lines 24. Like the valves 18 and choke 20, the valves 26 and chokes 28 can be provided in various forms.

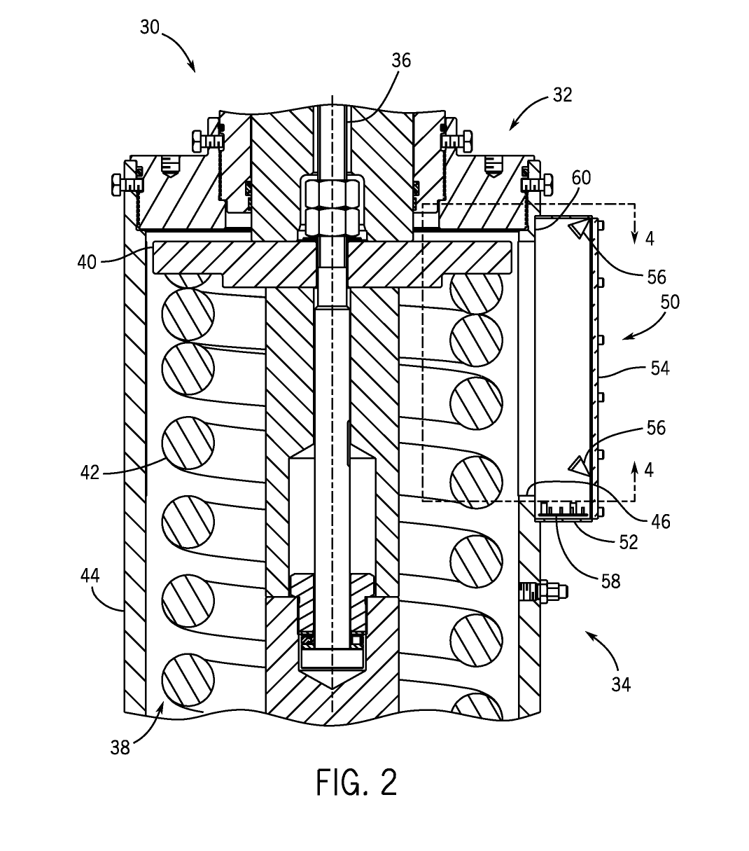

As may be appreciated, chokes and other valves include a flow control mechanism for selectively allowing flow through the valves. For instance, a gate valve includes a sliding gate having an aperture that may be moved into and out of alignment with the bore of a conduit to allow or inhibit flow. A choke can similarly include a movable element that is translated with respect to a stationary component to regulate flow through the choke. Adjustable chokes and other valves are often controlled with actuators coupled to their movable elements by stems. One example of such a valve is illustrated in FIG. 2.

In this embodiment, a valve 30 includes a main body 32 for housing the valve trim. The valve 30 can take the form of a gate valve, a choke, or some other valve. Further, the valve 30 can be used in the system 10 as a valve 18 or 26, or as a choke 20 or 28. As depicted in FIG. 2, an actuator assembly 34 is coupled to the main body 32. The actuator assembly includes an actuator 38 for controlling a movable portion of the valve trim (e.g., a gate, needle, or plug) via a stem 36. The actuator 38 is depicted in the present embodiment as having a spring plate 40 and a spring 42, although in other embodiments the actuator 38 could be provided in other forms. The spring plate 40 is coupled to move with the stem 36 when actuated, and the spring 42 biases the spring plate 40 toward a resting position (e.g., near the main body 32 in FIG. 2). Flow through the valve 30 is controlled by moving the stem 36 and the spring plate 40.

The actuator 38 is disposed within an actuator housing 44 of the assembly 34. The housing 44 includes a viewing port or aperture 46 and a position detector 50. Knowing the position of the actuator allows determination of the operating status of the valve (e.g., fully open, fully closed, or partially closed). If the position detector 50 were omitted, the viewing port 46 would permit an operator to manually view the position of the actuator within the actuator housing to determine the operating status of the valve 30. But such manual checking would require the operator to be present at the valve. Further, the valve could be positioned at an inconvenient location (e.g., high above the ground or below the platform level), making such manual checking even more difficult.

In the presently depicted embodiment, however, the position detector 50 allows the position of the actuator 38 (e.g., spring plate 40) to be automatically determined through use of computer vision techniques with image data from one or more cameras of the position detector 50. As illustrated in FIG. 2, the position detector 50 includes a detector housing 52, cameras 56 mounted inside the detector housing 52, and electronics 58. Components of the electronics 58 can be mounted inside or provided outside the detector housing 52. In at least some embodiments, the electronics 58 are provided in the form of a processing system for receiving image data from the cameras 56 and using that image data to determine the position of the actuator 38. The processing system can use any suitable machine vision or computer vision technique, such as known object tracking algorithms, to detect the location, relative movement, or other features of the actuator 38 in the image data. The system can then output (e.g., to a user) an indication of the position of the actuator 38. It is noted that, while the position detector 50 is presently described in the context of a valve actuator, it will be appreciated that the present techniques can be applied to other devices and systems, such as for detecting position of other movable objects in other flow control devices, wellhead equipment, or oilfield equipment.

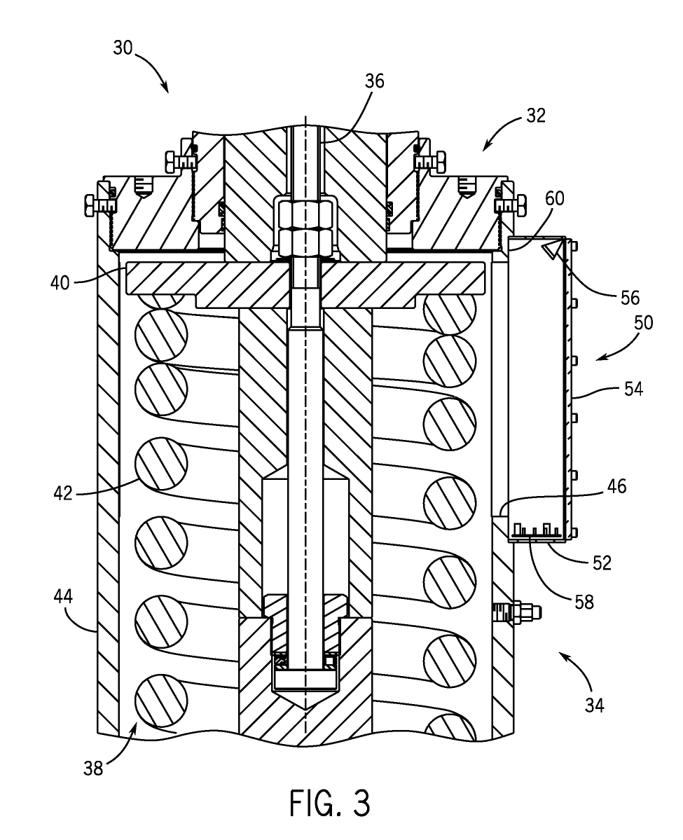

The position detector 50 can include any desired number of cameras 56 for collecting image data to be processed and from which the position of the actuator 38 can be determined. As depicted in FIG. 2, the position detector 50 can include two cameras 56. In one such embodiment, stereoscopic vision algorithms are used to determine the position of the actuator 38 from image data collected by both cameras 56. In other embodiments, the position of the actuator 38 is determined from the image data of a single camera 56. In these cases, the second camera 56 can be used as a standalone backup system to provide redundancy. That is, the processing system can use the image data from either camera independently to determine the position of the actuator 38 without reference to image data from the other camera. Or, as depicted in FIG. 3, the second camera 56 could be omitted and the position detector 50 could be provided with just a single camera 56. Of course, more than two cameras 56 could also be provided with the position detector 50 in other embodiments.

A viewing window 54 can be attached to the detector housing 52, as generally depicted in FIGS. 2 and 3. The viewing window 54 can be formed with a transparent material, such as acrylic or glass. This allows an operator to see into the actuator housing 44; view the actuator 38 through the viewing window 54, the position detector 50, and the aperture 46; and determine the status of the actuator (e.g., the position of the spring plate 40, and the condition of the spring plate 40 and the spring 42). The viewing window 54 can be fastened to the detector housing 52 with screws (heads of which are shown to the right of the viewing window in FIGS. 2 and 3), or coupled to the detector housing 52 in any other desired manner.

While the position detector 50 can be provided with new actuator assemblies not yet placed in service, the position detector 50 could also be retrofitted to an existing actuator assembly 34. In some such instances, and as depicted in FIGS. 2 and 3, the actuator housing 44 is adapted to receive a viewing window in a recess 60 of the actuator housing about the viewing port 46. The detector housing 52 can be attached to the actuator housing 44 in place of a viewing window. In fact, in one embodiment, the viewing window 54 attached to the detector housing 52 can have been previously installed on the actuator housing 44 itself. The viewing window 54 can be removed from the actuator housing 44 and the detector housing 52 can be attached to the portion of the actuator housing 44 vacated by the removal of the viewing window 54. The detector housing 52 could be fastened to the actuator housing 44 using the same screw holes previously used to fasten the viewing window to the actuator housing 44. Once removed from the actuator housing 44, the viewing window 54 can be reattached over an aperture in a side of the detector housing 52 opposite the viewing port 46. Alternatively, a new viewing window 54 can be provided with the detector housing 52. In some embodiments, the position detector 50 can be retrofitted to an actuator assembly 34 while it is in service without the use of power tools. Further, the position detector 50 depicted in FIG. 2 is a non-intrusive position detector in that this detector is positioned outside the actuator housing 44 so as to avoid interference with the operation of the actuator 38.

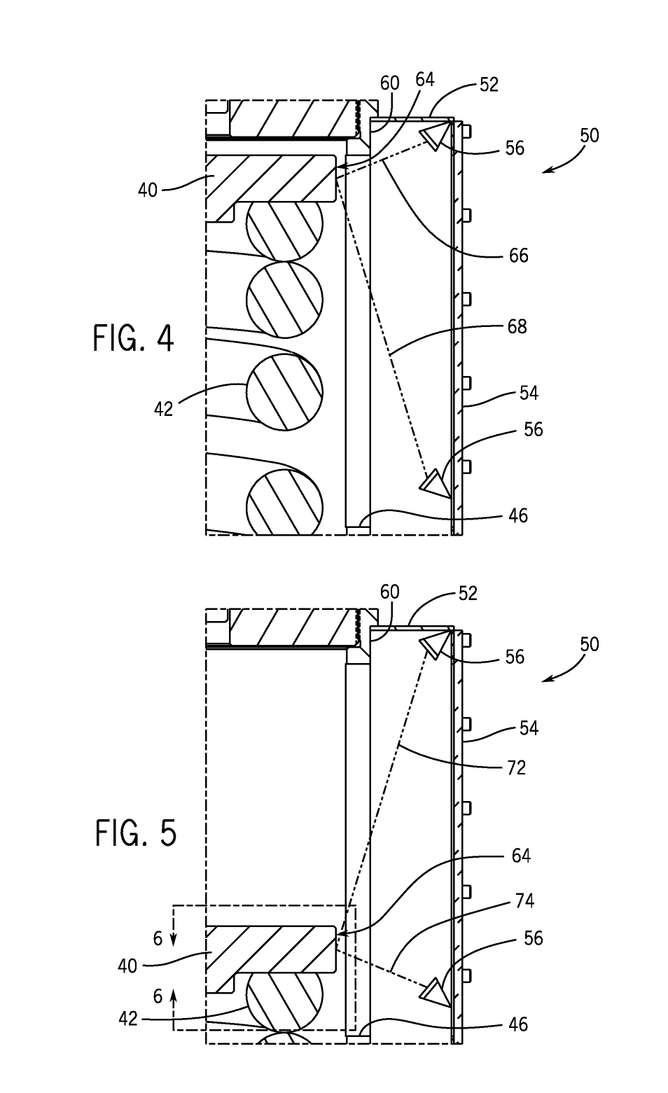

As shown in FIGS. 2 and 3, the position detector 50 has an open end and is installed over the aperture 46 of the actuator housing 44 so that the actuator (specifically the spring plate 40 in these figures) is within the field of view of the cameras 56. The two cameras 56 can view the spring plate 40 as it moves within the actuator housing 44. For instance, the cameras 56 can track the position of the spring plate 40 as it moves from the fully closed position shown in FIG. 4 to the fully open position shown in FIG. 5. In FIG. 4, the spring plate 40 is positioned comparatively close to the upper camera 56 and far from the lower camera 56. The upper camera 56 receives light reflected from an end 64 of the spring plate 40, generally represented by path 66, and the lower camera receives light reflected from the end 64 of the spring plate 40, generally represented by path 68. In FIG. 5, the spring plate 40 is positioned closer to the lower camera 56 and farther from the upper camera 56. In this position, the cameras 56 receive reflected light from the end 64 of the spring plate 40 along respective paths 72 and 74.

In some embodiments, a light source is provided to illuminate the actuator 38 inside the actuator housing 44 and facilitate the acquisition of image data by the cameras. The light source can include backlights integrated into the cameras 56. The light emitted from these backlights is reflected from the spring plate 40 (or other actuator components), and a portion of that reflected light is detected by the cameras 56. In other embodiments, the light source is mounted within the detector housing 52 separate from the cameras 56, or is provided outside the detector housing 52 in any position that would illuminate the actuator. Further, light emitted from the light sources could be provided in various forms, such as visible light, infrared light, or ultraviolet light. The light used can be selected to suit the surface (e.g., based on texture) of the actuator 38 to be tracked.

The position detector 50 in some embodiments is configured to detect foreign contamination within the actuator housing 44 or detector housing 52. For example, the processing system may evaluate image data from a camera 56 and correlate image degradation with the presence of a foreign substance, such as water, fluid, gas, or undesired solids in the path from the actuator to the camera 56. In another embodiment, the position detector 50 is configured to detect gas leakage into the actuator housing 44, such as from the main body 32. This detection can be based on measured absorption of light (e.g., infrared, visible, or ultraviolet light emitted by a light source) by gas along the path traveled by the light. Various gases have differing absorption characteristics and the light may be selected to optimize detection of certain types of gas (e.g., types of natural gas) within the actuator housing 44.

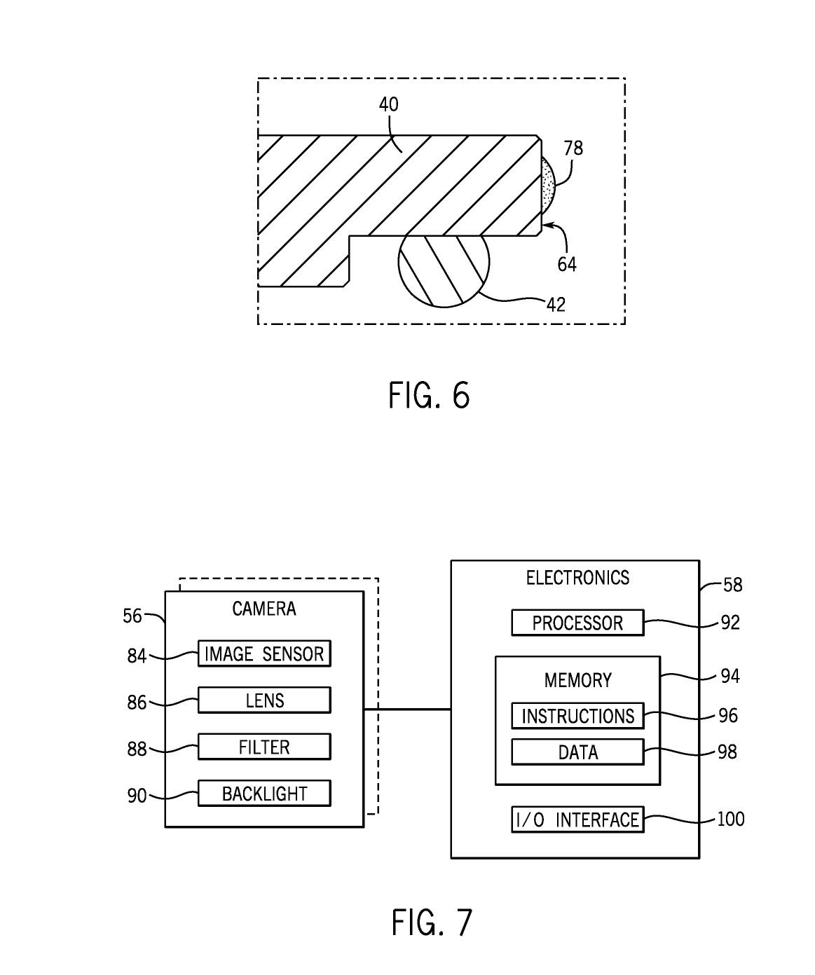

Additionally, a reflective material can be added to an actuator (e.g., when installing the position detector 50) to enhance reflection of light from the actuator. For example, as depicted in FIG. 6, a reflective material 78 can be provided on the end 64 of the spring plate 40. This reflective material 78 can take any suitable form, such as a dab of reflective paint or other material applied to the end 64 of the spring plate 40 during installation of the position detector 50.

Various components of the position detector 50 are generally depicted in FIG. 7 by way of further example. As noted above, the position detector can include one or more cameras 56 for acquiring image data and electronics 58 for processing the image data. The camera 56 is depicted here as including an image sensor 84, which can be provided as a charge-coupled device (CCD) or a complementary metal-oxide-sensor (CMOS), for instance. A lens 86 can be used to focus light on the image sensor 84, and various filters 88 can be used (e.g., over the lens 86) to filter specific wavelength ranges of light. For example, the filters 88 can include an infrared filter or an ultraviolet filter. It is noted, however, that certain processes may benefit from light of a certain wavelength and that filters 88 should be selected appropriately. For example, the camera 56 should not have a filter that blocks infrared light if the detector 50 is going to be used to measure absorbance of that infrared light to detect gas leakage into the actuator housing 44. The camera 56 can also include a backlight 90, as generally discussed above.

As depicted in FIG. 7, the electronics 58 include a processor 92 and a memory device 94. In at least some embodiments, the processor 92 and the memory device 94 are mounted in the detector housing 52. Application instructions 96 for performing the detection functionality described above can be stored in the memory device 94 and executed by the processor 92 as desired. Various data 98, including data related to the detection features, can be stored in the memory device 94 as well. A communications interface 100 facilitates communication between the electronics 58 and other devices (e.g., the camera 56 and a user terminal for displaying position indications). The processor 92 is connected (via interface 100) to receive and process image data form the cameras 56 to determine the position of the movable valve actuator 38 within the actuator housing 44. Indications of the detected position (or of detected contamination or gas leakage, as described above) can be output via the interface 100 (e.g., to a display, printer, external memory, or another processing device) or can be saved in the memory device 94.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. A system comprising:
a valve including:
a main body; and
an actuator to control flow through the valve, the actuator disposed within an actuator housing coupled to the main body; and
a position detector including a camera mounted inside a detector housing, wherein the detector housing is installed over an aperture in the actuator housing such that the actuator within the actuator housing is in view of the camera through the aperture.

2. The system of claim 1, comprising a processor connected to receive and process image data from the camera to determine the position of the actuator within the actuator housing.

3. The system of claim 2, wherein the processor is mounted within the detector housing.

4. The system of claim 1, wherein the position detector is configured to detect contamination within the actuator housing via image data from the camera.

5. The system of claim 1, comprising a light source positioned to illuminate the actuator inside the actuator housing.

6. The system of claim 5, wherein the position detector is configured to detect gas leakage into the actuator housing based on absorption by gas within the actuator housing of infrared or ultraviolet light emitted from the light source.

7. The system of claim 1, comprising a viewing window attached to the detector housing.

8. The system of claim 1, wherein the actuator housing is adapted to receive a viewing window over the aperture in the actuator housing and the detector housing is attached to the actuator housing in place of the viewing window.

9. The system of claim 8, wherein the viewing window is attached to the detector housing opposite the aperture in the actuator housing to enable an operator to view the actuator inside the actuator housing through the detector housing via the viewing window and the aperture in the actuator housing.

10. The system of claim 1, wherein the valve is a gate valve or a choke.

11. A system comprising:
a housing having an open end and configured to be coupled to a flow control device;
a camera mounted in the housing; and
electronics configured to process image data from the camera so as to determine the position of a movable object of the flow control device that is outside the housing and visible to the camera through the open end.

12. The system of claim 11, comprising an additional camera mounted in the housing.

13. The system of claim 12, wherein the electronics are configured to use the image data from both the camera and the additional camera to determine the position of the movable object.

14. The system of claim 12, wherein the additional camera adds redundancy and the electronics are configured to use the image data from either the camera or the additional camera independently.

15. The system of claim 11, wherein the flow control device is a valve and the movable object of the flow control device is a valve actuator.

16. A method comprising:
operating a camera mounted outside of an actuator housing to acquire image data of a movable valve actuator within the actuator housing; and
processing the image data to determine the position of the movable valve actuator within the actuator housing.

17. The method of claim 16, comprising illuminating the movable valve actuator with a backlight in a detector housing that also includes the camera.

18. The method of claim 16, comprising outputting an indication of the position of the movable valve actuator.

19. The method of claim 16, comprising installing a position detector on the actuator housing, the position detector including a detector housing containing both the camera and a processor for processing the image data to determine the position of the movable valve actuator.

20. The method of claim 19, wherein installing the position detector on the actuator housing includes retrofitting the actuator housing with the position detector by removing a viewing window from a portion of the actuator housing, attaching the detector housing to the portion of the actuator housing vacated by the removal of the viewing window, and reattaching the viewing window to the detector housing such that the detector housing is interposed between the viewing window and the actuator housing.
